(19) United States
(12) Patent Application Publication
(10) Pub. No.: US 2019/0196750 A1
(43) Pub. Date: Jun. 27, 2019

(54) CARTIDGE CHIP RESETTING CONTROL FOR IMAGING DEVICE

(71) Applicant: Guangzhou ZHONO Electronic Technology Co., Ltd., Guangzhou (CN)

(72) Inventors: Weihu DUAN, Guangzhou (CN); Yan'an YANG, Guangzhou (CN); Bo Wang, Guangzhou (CN); Hongcheng MAO, Guangzhou (CN)

(21) Appl. No.: 16/224,156

(22) Filed: Dec. 18, 2018

Related U.S. Application Data
(63) Continuation of application No. PCT/CN2017/117905, filed on Dec. 22, 2017.

(30) Foreign Application Priority Data
Dec. 22, 2017 (CN) 201711401129.3

(51) Int. Cl. G06F 3/12

(52) U.S. Cl. CPC G06F 3/121; G06F 3/1234; G06F 3/122

(57) ABSTRACT

A method of resetting a chip for an imaging device, a cartridge chip and a consumer container are provided. The method comprises: obtaining a part of or complete printing information of an imaging cartridge data of the chip in operation; detecting an exceptional status of the chip, and generating an exceptional tag according to the exceptional status; generating a resetting information according to the exceptional tag and/or the printing information, and obtaining a resetting data according to the resetting information; and performing a resetting operation using the resetting data.

### RELATED APPLICATIONS

This U.S. application claims priority under 35 U.S.C 111(a) to, and is a U.S. continuation application of, the International Patent Application No. PCT/CN2017/117905, filed on Dec. 22, 2017, which claims the benefit of prior Chinese Application No. 201711401129.3 filed on Dec. 22, 2017. The entire contents of the before-mentioned patent applications are incorporated by reference as part of the disclosure of this U.S. application.

### FIELD

The present disclosure relates to imaging process field, more particularly, to a cartridge chip reset method and a chip using the method thereof for an imaging device.

### BACKGROUND

An imaging cartridge having a chip is normally installed on an imaging device such as a duplicating machine, a printer, a facsimile machine and a multifunctional word processing machine etc. The chip is stored with imaging cartridge data or information such as manufacturer code, serial number, version number, manufacturing date, model series, machine parameters, consumable volume and consumable consumption volume etc. In operation, the imaging device may communicate with the chip, and verify the validity of the stored data in the chip. Once illegal items may be existed in the data stored in the chip, the communication between the imaging device and the chip may be rejected, resulting non-service of the imaging cartridge having the chip for the imaging device.

In prior art, although a device for resetting the chip may exist, the device may only reset a chip under the condition that the non-use of the chip by an imaging device is caused by consumable consumption volume stored in the chip reaching maximum. And normally the resetting is accomplished simply by burning imaging cartridge data into the chip again, such as the solution disclosed in Chinese patent application CN201020581469.6. However, During the operation of the chip, one or more exceptions may cause the chip being recognized by the imaging device as invalid, such as developer dropping non-smoothness, total or partial consumable consumption volume or version exception, non-detectability of the chip, use markup exception etc. When the chip is verified as invalid by the imaging device in this way, the chip is correspondingly communication denied, refusing to communicate with the chip. If the communication denied chip is restored, it may only be performed by the original manufacturer, professional personnel or professional devices. However, normal user of the imaging device does not have the capability or condition of repairing the communication denied chip. Once the chip is denied communication, the chip is discarded or sent back to the chip manufacturer or reset by dedicated devices, resulting in unnecessary waste and deterioration of user's experience.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

To solve the above problems, the present disclosure may provide a method for resetting a written-dead chip, a chip using the resetting method and a consumable container.

According to an embodiment of the present disclosure, a method of resetting a chip for an imaging device may be provided, the method may comprise the steps of obtaining a part of or complete printing information of an imaging cartridge data of the chip in operation; detecting an exceptional status of the chip, and generating an exceptional tag according to the exceptional status; generating a resetting information according to the exceptional tag and/or the printing information, and obtaining a resetting data according to the resetting information; and performing a resetting operation using the resetting data.

According to another embodiment of the present disclosure, a chip for an imaging device may be provided. The chip may comprise a circuit board; and a reset device disposed on the circuit board. The reset device may comprise a recording module obtaining a part of or complete printing information of an imaging cartridge during operation and storing the printing information; a detecting module detecting an exceptional status of the chip and generating an exceptional tag according to the exceptional status; a backup module for storing resetting data; and a reset module generating resetting information according to the exceptional tag and/or the printing information, and sending a resetting information to the backup module. The backup module may obtain a corresponding resetting data according to the resetting information after receiving the resetting information, and send the resetting data to the reset module. And the reset module may perform a corresponding resetting operation using the resetting data.

According to still another embodiment of the present disclosure, a consumable container may be provided, comprising a consumable cartridge and the aforementioned chip installed in the consumable cartridge.

The present disclosure may have the following advantages. Compared with prior art, a reset device may be provided in the chip, corresponding resetting data may be obtained by the exceptional status of the resetting device and the printing information of the printing device. And the chip may be reset by the resetting data. And the chip may be automatically reset in a relatively accurate way when exception may occur. And the chip may not need to be sent to the original manufacturer for resetting when the chip is denied communication. And the communication denied chip may be reset during customer's usage, thus enhancing utilizing rate of the chip and further reducing chip waste.

### BRIEF DESCRIPTION OF THE DRAWINGS

These and other aspects and advantages of the present disclosure will become apparent and more readily appreciated from the following descriptions taken in conjunction with the drawings in which:

FIG. 1A is a block diagram of a consumable container according to an embodiment of the present disclosure;

FIG. 1B is a block diagram of a reset module in a chip according to an embodiment of the present disclosure;

FIG. 2 is a flow diagram of a reset method according to an embodiment of the present disclosure; and

FIG. 3 is a flow diagram of a reset method using resetting data according to an embodiment of the present disclosure.

### DETAILED DESCRIPTION

Descriptions will be made in detail to embodiments of the present disclosure, examples of which are illustrated in drawings, in which the same or similar elements and the elements having same or similar functions are denoted by like reference numerals throughout the descriptions. The embodiments described herein with reference to drawings are explanatory, are intended to understand the present disclosure, and are not construed to limit the present disclosure.

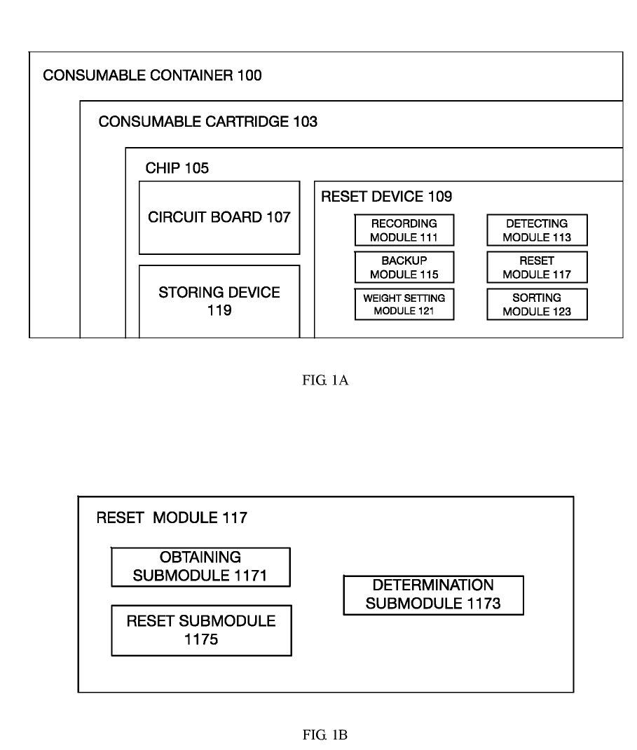

According to an embodiment of the present disclosure, as shown in FIG. 1A and FIG. 1B, a consumable container 100 may comprise a consumable cartridge 103 and a chip 105 disposed in the consumable cartridge 103. The consumable cartridge 103 may be used for containing ink or carbon developer etc. the chip 105 may be stored with EEPROM data. The chip 105 may comprise a circuit board 107 and a reset device 109 provided on the circuit board. Referring to FIG. 1, the reset device 109 may comprise: a recording module 111 for obtaining a part of or a complete printing information of an imaging cartridge data of the chip 105 during operation and storing the printing information; a detecting module 113 for detecting an exceptional status of the chip 105 and generating an exceptional tag according to the exceptional status; a backup module 115 for storing resetting data; a reset module 117 generating the resetting information according to the exceptional tag and/or the printing information, and sending a resetting information to the backup module 115. The backup module 115 may obtain a corresponding resetting data according to the resetting information after receiving the resetting information, and send the resetting data to the reset module 117. And the reset module 117 may perform a corresponding resetting operation using the resetting data. Of course, the chip 105 may further comprise a storing device 119 for storing EEPROM data.

When there are two or more reset modes, the reset device 109 may further comprise a weight setting module 121 and a sorting module 123.

The weight setting module 121 may be used for matching the exceptional tag and the reset mode, and setting a weight value of the corresponding reset mode according to the matching degree. The sorting module 123 may sort the reset modes based on the weight values accordingly.

The reset module 117 may further comprise the following submodules: an obtaining submodule 1171 for obtaining the corresponding resetting data based on the sorted reset modes; a determination submodule 1173 for determining whether an unusable tag may exist in the resetting data; a reset submodule 1175 for performing the resetting operation using the resetting data according to the corresponding reset mode if the determination submodule 1173 may determine that no unusable tag exists in the resetting data, and obtaining other resetting data according to other reset mode respectively if the unusable tag exists in the resetting data.

According to an embodiment of the present disclosure, the printing information may comprise at least one of consumable volume, consumable consumption volume and use markup.

According to an embodiment of the present disclosure, the resetting data may comprise at least one of backup serial number information, version information, consumable volume information, and consumable consumption information.

According to an embodiment of the present disclosure, the exceptional status may comprise at least one of non-detectability, serial number exception, consumable volume exception, and developer dropping exception.

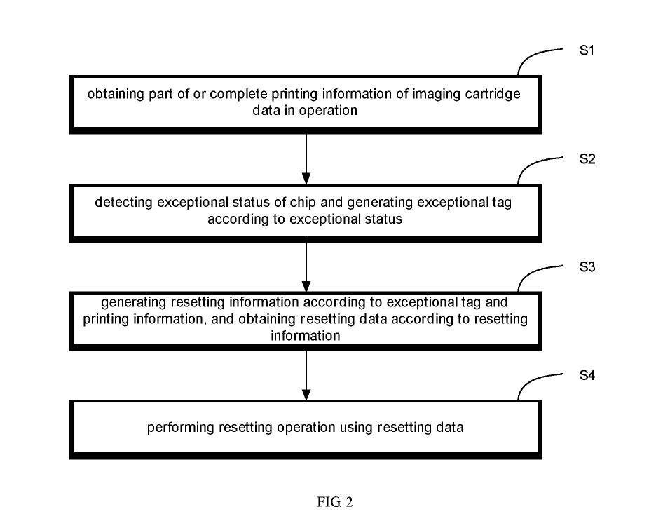

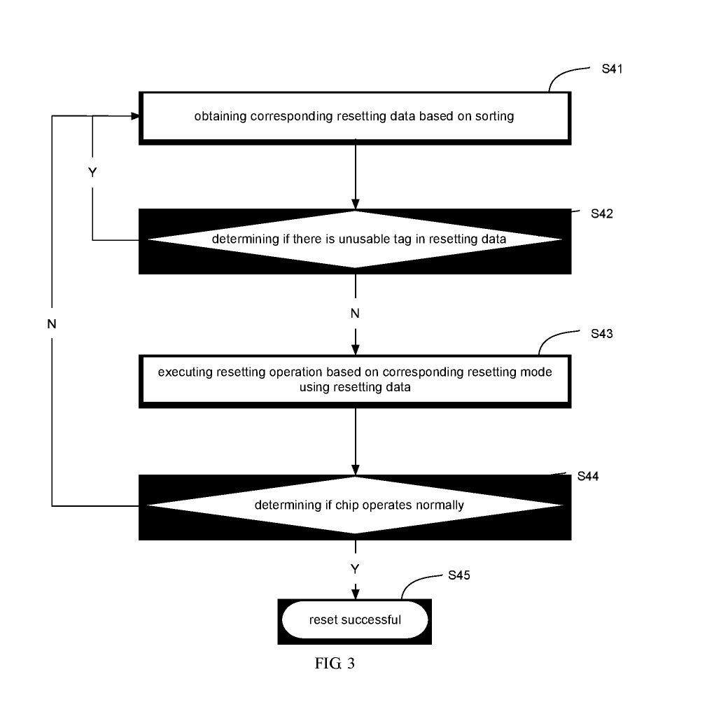

Referring to FIGS. 2 and 3, according to another embodiment of the present disclosure, a method for resetting a chip for an imaging device may be provided. According to an embodiment of the present disclosure, the imaging device may be a duplicating machine, a printer, a facsimile machine or a multifunctional word processing machine etc. The method may comprise the following steps.

As shown in FIG. 2, in step S1, a part of or complete printing information of an imaging cartridge data i.e. EEPROM data, of the chip 105 in operation may be obtained by the recording module 111. And the printing information may be sent to the reset module 117 by the recording module 111.

In step S2, exceptional status of the chip 105 may be detected by the detecting module 113, and the exceptional tag may be generated by the exceptional status. The exceptional tag generated by the detecting module 113 may be sent to the reset module 117. It should be noted that the exceptional status may only occur when exception occurs for the chip 105, and exceptional tag may be generated accordingly. If the chip 105 may be used normally, the detecting module 113 may not detect, or may not generate the exceptional tag when no exception is detected. It should be noted that the steps S1 and S2 may be executed in a switchable manner.

In step S3, a resetting information according to the exceptional tag and/or the printing information may be generated by the reset module 117, and a resetting data according to the resetting information may be obtained from the backup module 115. For example, an A-class resetting information may be generated according to the non-detectability exceptional tag and the printing information of normal consumable volume. Or a B-class resetting information may be generated based on an exceptional tag of developer dropping non-smoothness and a printing information of partial normal volume and partial abnormal volume. And at least one of serial number information, version information, consumable volume information and consumable consumption information may be obtained based on the A-class resetting information and B-class resetting information.

In Step S4, a resetting operation using the resetting data may be performed by the reset module 117.

There may be at least one reset mode. When there may be two or more reset modes, after sorting of the reset modes, the resetting operations may be performed respectively following the sorting order of the reset modes. For example, the reset mode may comprise serial number switching, data rewriting, exceptional tag clearing, version switching and volume resetting etc. The reset modes may be stored in the reset module 117.

The sorting method of the reset modes may comprise the following steps. Step S1′, matching the exceptional tag and the reset mode to obtain a matching degree, and setting a weight value according to the matching degree. For example, an exceptional tag of non-detectability may be generated by the detecting module, the exceptional tag of non-detectability may have a higher matching degree with the serial number switching, less with version switching, more less with volume resetting, further more less with exception tag clearing and least with data rewriting. And weight value of 1/2/3/4/5 may be set for serial number switching, version switching, volume resetting, exceptional tag clearing and data rewriting respectively. Step S2′, the reset modes may be sorted according to the weight values accordingly. For example, the weight value itself may be used for the sorting.

Referring to FIG. 3, the step of performing or executing a resetting operation using the resetting data may comprise the following steps. Step S41, corresponding resetting data may be obtained using the sorted reset modes. Since the resetting data and the reset mode have correlation, the resetting data is sorted following the reset modes. The resetting data in front after sorting may be firstly obtained. For example, the mode of serial number switching may correspond with the serial number data. The mode of version switching may correspond with the version data. The mode of volume resetting may correspond with the volume data. And the data rewriting may correspond with all the EEPROM data etc. Step S42, determining whether an unusable tag may exist in the resetting data. Step S43, if not, performing the resetting operation using the resetting data according to the corresponding reset mode. Otherwise, the step S41 may be returned, to continuously execute the resetting operation based on the sorting to obtain other resetting data.

After performing the resetting operation based on the corresponding reset mode using the resetting data, the chip 105 may be determined to work normally or not (step S44). If yes, the chip 105 resetting may be successful (step S45). Otherwise, the step S41 may be returned to continuously perform the resetting operation by obtaining other resetting data based on the sorting again, and the unusable tag may be tagged for the corresponding resetting data.

The following embodiments will further explain the chip reset principle of the consumable container, the chip and the chip resetting method.

### First Embodiment

The chip may be detected by the detecting module as write non-detectability, the consumable volume may be recorded as 100% with non-use markup by the recording module. The resetting module may obtain the resetting information of serial number switching. Then, the serial number information may be obtained from the backup module 115 by the resetting module, for resetting by serial number switching. Of course, the sorting may be performed by the resetting module by matching the exceptional information of write non-detectability with the resetting modes such as the serial number switching, data rewriting, exceptional tag clearing, version switching and volume resetting etc. And the resetting modes sorted in the front may firstly be executed. After one execution, the chip resetting is determined to be successful or not. If yes, the resetting operation may be terminated, otherwise the next reset mode may be used for the resetting operation until successful. It may be presumed that the reset modes may be sorted as serial number switching, data rewriting, exceptional tag clearing, version switching and volume resetting. The serial number switching may be firstly executed, if the chip may not be reset successfully, the serial number data may be tagged with an unusable tag, and the data rewriting may then be executed . . . and all the sorted reset modes may be executed in turn respectively until resetting may be successful. After success, all the unusable tags may be cleared. If all the resetting modes may be executed and the chip still may not be reset successfully, the chip may be written with a communication denied tag. Normally, the chip may be reset successfully, and only under rare extreme conditions may the resetting of the chip be unsuccessful.

### Second Embodiment

The chip may be detected by the detecting module as developer dropping non-smoothness. The consumable volume may be recorded as 50% with use markup by the recording module. Thus, the EEPROM data for the previous 50% consumable volume may be normal data. The resetting information for the data rewriting may be obtained by the resetting module. Then, the EEPROM data of the previous 50% consumable volume may be obtained from the backup module 115 by the resetting module to reset in the data rewriting mode. Of course, sorting may be performed by the resetting module by matching the exceptional information of developer dropping non-smoothness with the resetting modes such as the serial number switching, data rewriting, exceptional tag clearing, version switching and volume resetting etc. And the resetting modes sorted in the front may firstly be executed. After one execution, the chip resetting may be determined to be successful or not. If yes, the resetting operation may be terminated, otherwise the next resetting mode may be used for the resetting operation until successful. It may be presumed that the resetting modes may be sorted as data rewriting, exceptional tag clearing, version switching, volume resetting and serial number switching. The data rewriting may be firstly executed, if the chip may not be reset successfully, the exceptional tag clearing may then be executed . . . and all the sorted reset mode may be executed in turn until the resetting may be successful.

### Third Embodiment

Version exception may be detected by the detecting module, showing there may be version exception for the chip. The resetting information for the needed switching may be obtained by the resetting module, then new version data may be obtained from the backup module 115 by the resetting module to reset in a version switching mode. Of course, sorting may be performed by the resetting module by matching the exceptional information of version exception with the resetting modes such as the version switching, serial number switching, data rewriting, exceptional tag clearing, and volume resetting etc. And the resetting modes sorted in the front may firstly be executed. After one execution, the chip resetting is determined to be successful or not. If yes, the resetting operation may be terminated, otherwise the next resetting mode may be used for the resetting operation until successful. The specific process may be referred to as stated in the first and second embodiments described above.

As stated above, resetting data may be obtained by the exceptional status of the chip and the printing information of the printing device. And the chip may be reset by the resetting data. And the chip may be automatically reset in a relatively accurate way when exception may occur. And the chip may not need to be sent to the original manufacturer for resetting. And the chip may be reset during customer's usage, thus enhancing utilizing rate of the chip and further reducing chip waste. In addition, the resetting modes for the resetting operation may be sorted accordingly, so that the chip may be performed with resetting operation in a specific order, thus further enhancing the successful possibility of resetting the chip.

Although explanatory embodiments have been illustrated and described, it would be appreciated by those skilled in the art that the above embodiments cannot be construed to limit the present disclosure, and changes, alternatives, and modifications can be made in the embodiments without departing from spirit, principles and scope of the present disclosure.

What is claimed is:

1. A method of resetting a chip for an imaging device, comprising steps of:
obtaining a part of or complete printing information of an imaging cartridge data of the chip in operation;
detecting an exceptional status of the chip, and generating an exceptional tag according to the exceptional status;
generating a resetting information according to the exceptional tag and/or the printing information, and obtaining a resetting data according to the resetting information; and
performing a resetting operation using the resetting data.

2. The method of claim 1, wherein there is at least one reset mode for the resetting operation;
when there are two or more reset modes, after sorting of the reset modes, the resetting operation is performed respectively following sorting order of the reset modes.

3. The method of claim 2, wherein the sorting of the reset modes comprises the steps of:
obtaining a matching degree by matching the exceptional tag with the reset mode respectively, and setting a weight value according to the matching degree; and
sorting the reset modes according to the weight values.

4. The method of claim 2, wherein the step of performing a resetting operation using the resetting data comprises steps of:
obtaining corresponding resetting data according to the sorted reset mode;
determining whether an unusable tag exists in the obtained resetting data;
if not, performing the resetting operation using the resetting data according to the corresponding reset mode;
if an unusable tag exists in the resetting data, obtaining other resetting data according to other reset modes respectively by executing the step of obtaining corresponding resetting data according to the sorted reset mode.

5. The method of claim 4, wherein after performing the resetting operation using the resetting data according to the corresponding reset mode, further comprising:
determining whether the chip operates normally or not;
if not, obtaining again other resetting data according to other reset modes respectively.

6. The method of claim 1, wherein the printing information comprises at least one of consumable volume, consumable consumption volume and use markup.

7. The method of claim 1, wherein the resetting data comprises at least one of backup serial number information, version information, consumable volume information, and consumable consumption information.

8. The method of claim 1, wherein the exceptional status comprises at least one of serial number exception, version exception, consumable volume exception, developer dropping exception.

9. The method of claim 1, wherein the imaging device is at least one of a duplicating machine, a printer, a facsimile machine or a multifunctional word processing machine.

10. A chip for an imaging device, comprising:
a circuit board; and
a reset device provided on the circuit board, comprising:
a recording module for obtaining a part of or complete printing information of an imaging cartridge during operation and storing the printing information;
a detecting module for detecting an exceptional status of the chip and generating an exceptional tag according to the exceptional status;
a backup module for storing resetting data;
a reset module for generating resetting information according to the exceptional tag and/or the printing information, and sending a resetting information to the backup module, wherein
the backup module obtains a corresponding resetting data according to the resetting information after receiving the resetting information, and sends the resetting data to the reset module; and
the reset module performs a corresponding resetting operation using the resetting data.

11. A consumable container, comprising:
a consumable cartridge; and
a chip disposed on the consumable cartridge according to claim 10.
